(19) United States
(12) Patent Application Publication
(10) Pub. No.: US 2008/0073917 A1
(43) Pub. Date: Mar. 27, 2008

(54) DUAL OUTPUT JACKSCREW CINCHING LATCH

(76) Inventors: Michael A. Ciavaglia, Dearborn, MI (US); Frank J. Arabia, Macomb, MI (US); Todd A. Suddon, Clarkston, MI (US)

Correspondence Address: DELPHI TECHNOLOGIES, INC., M/C 480-410-202, PO BOX 5052, TROY, MI, 48007, US

(21) Appl. No.: 11/862,992

(22) Filed: Sep. 27, 2007

Related U.S. Application Data
(60) Provisional application No. 60/847,517, filed on Sep. 27, 2006.

(51) Int. Cl. E05C 3/12

(52) U.S. Cl. 292/201

(57) ABSTRACT

A cinching latch assembly having a housing having with a first and second cam surfaces is disclosed herein. A reversible electric motor is mounted to the housing. A drive screw is drivingly connected to the reversible motor, the drive screw having a first end portion and a second end portion. A carrier nut is movably positioned on the drive screw, the carrier nut including a first appendage, the drive screw being selectively rotated in a first direction and a second direction to move the carrier nut from a first home position toward the first end portion and then back towards a second home position to establish a latched configuration of the cinching latch assembly, and the drive screw being selectively rotated in the second direction and the first direction to move the carrier nut from the second home position toward the second end portion and then back towards the first home position to establish an unlatched configuration of the cinching latch assembly, the carrier nut and the first appendage moving in at least two different directions as the carrier nut is moved from the first home position to the latched position and as the carrier nut is moved from the latched position to the second home position.

### CROSS REFERENCE TO RELATED APPLICATIONS

This application claims the benefit of U.S. Provisional Patent Application Ser. No. 60/847,517 filed Sep. 27, 2006, the contents of which are incorporated herein by reference thereto.

### BACKGROUND

Exemplary embodiments of the present invention relate to door and movable panel latches and, more particularly, to door and movable panel cinching latches for vehicles.

A vehicle frequently includes displaceable panels such as doors, hood, trunk lid, hatch and the like which are affixed for hinged or sliding engagement with a host vehicle body. Cooperating systems of latches and strikers are typically provided to ensure that such panels remain secured in their fully closed position when the panel is closed.

A door latch typically includes a fork bolt that is pivoted between an unlatched position and a primary latched position when the door is closed to latch the door in the closed position. The fork bolt is typically held in the primary latched position by a detent lever that pivots between an engaged position and a disengaged position. The detent lever holds the fork bolt in the primary latched position when in the engaged position and releases the fork bolt when in the disengaged position so that the door can be opened.

The fork bolt is pivoted to the primary latched position by a striker attached to, for example, an associated door jamb when the door is closed. In some instances, the door may not be closed with enough force to fully pivot the fork bolt to the primary latched position where the primary latch shoulder is engaged. Therefore, in order to ensure that the door is latched, the fork bolt includes a secondary latch shoulder that is easily engaged by the detent lever with this construction, the possibility that the door will open when the vehicle is in operation is minimized. This is known as the secondary latched position. Often times, the door may be in the secondary latch position without the operator's knowledge. Thus, while the panel is latched, it would be beneficial to ensure that the panel is in the primary latched position.

Accordingly, it is desirable to provide an automatically operated door latch assembly. More specifically, it is desirable to provide an automatically operated door latch assembly that employs an electric motor to move a fork bolt to and from a fully latched position.

### SUMMARY OF THE INVENTION

In accordance with an exemplary embodiment of the invention, a cinching latch assembly is provided. The cinching latch assembly having a housing with first and second cam surfaces. A reversible electric motor is mounted to the housing. A drive screw is drivingly connected to the reversible motor, the drive screw having a first end portion and a second end portion. A carrier nut is movably positioned on the drive screw, the carrier nut including a first appendage, the drive screw being selectively rotated in a first direction and a second direction to move the carrier nut from a first home position toward the first end portion and then back towards a second home position to establish a latched configuration of the cinching latch assembly, and the drive screw being selectively rotated in the second direction and the first direction to move the carrier nut from the second home position toward the second end portion and then back towards the first home position to establish an unlatched configuration of the cinching latch assembly, the carrier nut and the first appendage moving in at least two different directions as the carrier nut is moved from the first home position to the latched position and as the carrier nut is moved from the latched position to the second home position.

In accordance with another exemplary embodiment of the present invention, a method of cinching a latch assembly is provided, the method comprising: linearly translating a carrier nut from a first home position to an latched position by driving a drive screw in a first direction by a reversible motor; rotating a fork bolt from a secondary position to a primary latched position when the carrier nut is translated from the first home position to the latched position; linearly translating the carrier nut from the latched position to a second home position by driving the drive screw is a second direction after the fork bolt is in the primary latched position; linearly translating the carrier nut from the second home position to an unlatched position by driving the drive screw in the second direction; rotating the fork bolt from the primary latched position to an unlatched position when the carrier nut is translated from the second home position to the unlatched position; and linearly translating the carrier nut from the unlatched position to the first home position by driving the drive screw is the first direction.

Additional objects, features and advantages of the various aspects of exemplary embodiments of the present invention will become more readily apparent from the following detailed description in conjunction with the drawings wherein like reference numerals refer to corresponding parts in the several views.

### BRIEF DESCRIPTION OF THE DRAWINGS

FIG. 1 is a perspective view of a cinching latch assembly embodying the present invention shown in a home position;

FIG. 1A is a perspective view of a cinching latch assembly embodying the present invention shown in an unlatched configuration;

FIG. 1B is a perspective view of a cinching latch assembly embodying the present invention shown in a latched configuration;

FIG. 2 is an exploded view of the latch assembly of FIG. 1;

FIG. 3 is a perspective view of the cinching latch assembly of FIG. 1;

FIG. 4 is a perspective view of the cinching latch assembly of FIG. 2 with a housing assembly cover removed to expose further details thereof;

FIG. 5 is a bottom perspective view of the cinching latch assembly of FIG. 4;

FIG. 6 is a bottom perspective view of the cinching latch assembly of FIG. 4, with a portion of a housing assembly removed to illustrate further internal details thereof;

FIG. 7 is a perspective view of the cinching latch assembly of an exemplary embodiment of the present invention;

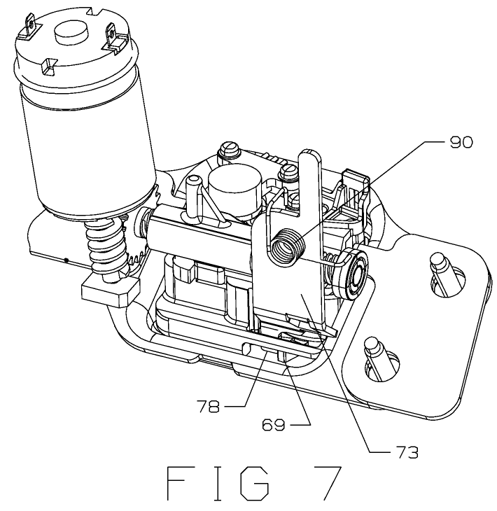

FIG. 8 illustrates operational positions of component parts of the cinching latch assembly constructed in accordance with an exemplary embodiment of the present invention;

FIG. 9 is a schematic illustration of an exemplary embodiment of the present invention; and

FIG. 10 is a bottom perspective view illustrating a portion of an exemplary embodiment of the present invention.

Although the drawings represent varied embodiments and features of the present invention, the drawings are not necessarily to scale and certain features may be exaggerated in order to illustrate and explain the present invention. The exemplification set forth herein illustrates several aspects of the invention, in one form, and such exemplification is not to be construed as limiting the scope of the invention in any manner.

### DETAILED DESCRIPTION OF EXEMPLARY EMBODIMENTS

Exemplary embodiments of the present invention relate to an apparatus and method for providing a cinching latch assembly. Furthermore, exemplary embodiments are directed to a bi-directional motor drive actuator operative to move levers to provide a robust, inexpensive structurally simple override function.

In accordance with exemplary embodiments of the present invention a motor turns in one direction for power cinching and in the opposite direction for power unlatching. The motor turns a pinion or worm and engages with a gear train. The output of the gear train rotates a jackscrew, ball screw or lead screw. The lead screw drives a nut axially back and forth. The nut has at least one or two appendages. One appendage of the nut pin follows two cam surfaces one to cinch and one to unlatch. The cam surfaces determine the attitude of the nut. The other appendage of the nut comprises a drive lug that engages a cinch lever for power cinching. The cinch lever rotates with the fork bolt with the latch in a secondary position the nut drive lug must engage the cinch lever. In order to do this, the moment arm with the fork bolt is quite small. The cinch arm surface rotates the nut so that the moment arm to the cinch lever is increased. The moment arm is maximized as the fork bolt rotates to the primary latch position. Once the latch is in primary, the motor receives a reverse pulse. This rotates the nut to the unlatch cam surface and disengages the nut drive lug from the cinch lever.

Power unlatching is achieved by reversing the motor polarity or using the same polarity to disengage the nut drive lug from the cinch lever. The nut is then guided by the unlatch cam surface and the nut travels along the screw and engages a detent release lever the detent release lever raises the detent to unlatch the latch and then the fork bolt is free to rotate from latched to unlatched. Once the fork bolt rotates to the open position or unlatched position, the motor receives a reverse pulse which then allows the detent to engage the fork bolt should the same be rotated into a latched or primary position again.

In the event of a power failure, the nut or the nut appendage must be rotated to the opposite cam surface to allow the drive lug to disengage from either the detent release lever or the cinching lever. This may be achieved by pushing on the nut pin directly or by having another lever engage the nut to reduce the override effort. Once the nut is rotated to the override position, both the cinch and detent release levers are allowed full range of motion (i.e. the detent will fully engage with the fork bolt in a full-bite condition).

The override effort is directly related to the lead of the screw. A larger lead directly relates to higher override efforts and likewise a smaller lead relates to lower efforts. This can be used with both backdrivable and non-backdrivable gear trains. The cam surfaces are set up to ensure proper disengagement from the cinch and detent release levers.

As used herein, the terms “first,” “second,” and the like, herein do not denote any order, quantity, or importance, but rather are used to distinguish one element from another, and the terms “a” and “an” herein do not denote a limitation of quantity, but rather denote the presence of at least one of the referenced item. In addition, it is noted that the terms “bottom” and “top” are used herein, unless otherwise noted, merely for convenience of description, and are not limited to any one position or spatial orientation.

The modifier “about” used in connection with a quantity is inclusive of the stated value and has the meaning dictated by the context (e.g., includes the degree of error associated with measurement of the particular quantity).

The contents of each of the following U.S. Patents are incorporated herein by reference thereto: U.S. Pat. No. 6,550,825 to Ostrowski et al. entitled “Cinching Door Latch with Planetary Release Mechanism”; U.S. Pat. No. 6,123,372 to Rogers et al. entitled “Door Larch”; U.S. Pat. No. 5,639,130 to Rogers et al. entitled “Rotary Door Cinching Mechanism with Manual Override”; U.S. Pat. No. 5,918,917 to Elton et al. entitled “Vehicle Door Latch with Cinching Mechanism”; and U.S. Pat. No. 6,092,336 to Wright et al. entitled “Power Liftgate Cable Drive with Position Stop”.

The following non-limiting examples further illustrate the various embodiments described herein.

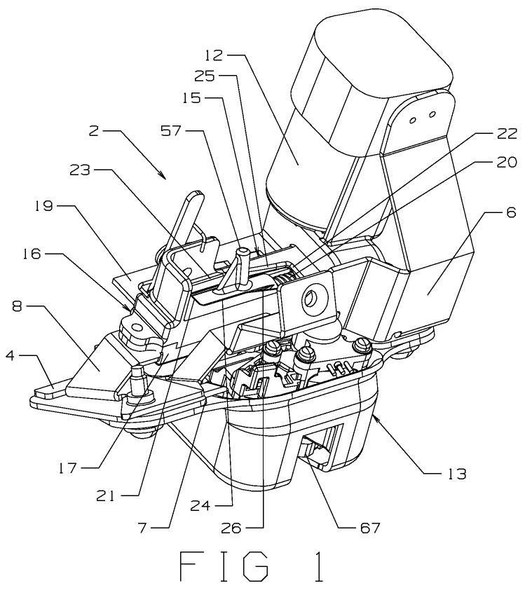

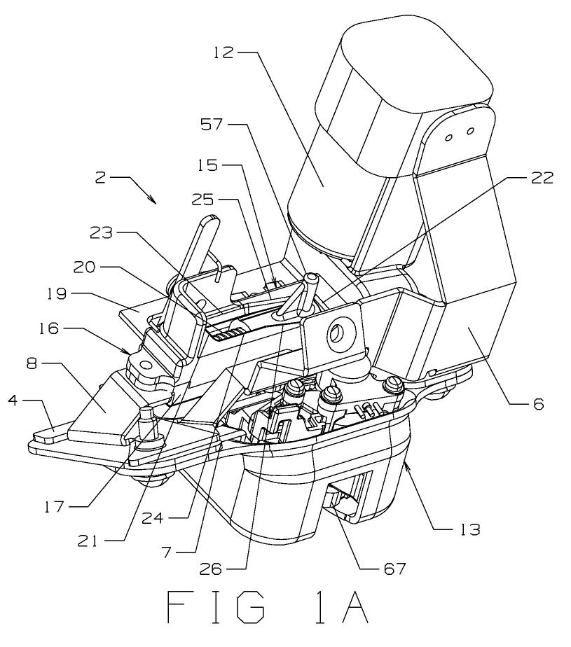

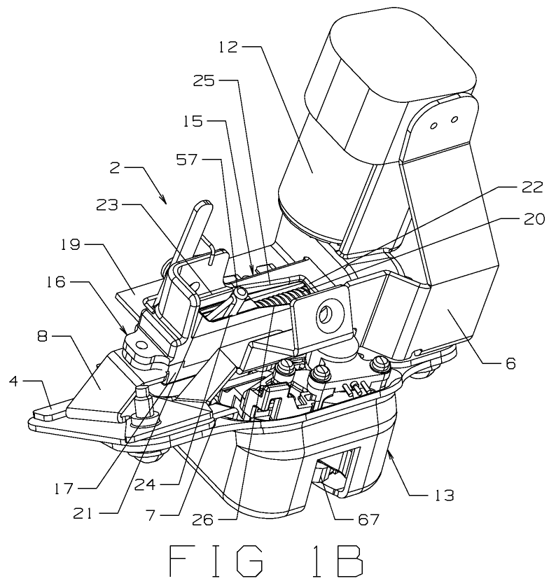

With initial reference to FIGS. 1, 1A, and 1B a cinching latch assembly constructed in accordance with an exemplary embodiment of the present invention is generally indicated at 2. Cinching latch assembly 2 includes a main housing 4 having a plurality of mounting brackets 6-8. As illustrated, mounting bracket 6 supports a reversible motor 12 while mounting bracket 7 supports a latch assembly 13 and mounting bracket 8 supports a latch operating mechanism or actuator assembly 15.

In accordance with an exemplary embodiment of the present invention the latch assembly rotatably receives a fork bolt having an aperture or receiving area configured to engage a striker or other equivalent member of the vehicle door panel. The fork bolt is configured to rotate from a primary or latched position to a secondary or half latched position to a fully open or unlatched position. Furthermore, the fork bolt is further configured to rotate from the unlatched position to the secondary or half latched position to the primary or latched position. In one exemplary embodiment, the fork bolt is spring biased such that movement of the detent release lever allows the fork bolt to rotate into the unlatched position while movement of the fork bolt from the unlatched to the latched position requires the biasing force of the spring to be overcome.

Actuator assembly 15 further comprises a housing assembly 16, which in an exemplary embodiment is secured to main housing 4. As shown, housing assembly 16 has a first housing portion 17 and a second housing portion 19. The first housing portion has an opening 18 while the second housing portion has an opening 20.

Opening 20 includes a first end portion 21 that defines a first travel limit position, and a second end portion 22 that defines a second travel limit position. First and second end portions or travel limit positions 21 and 22 are interconnected through a pair of opposing side portions 23 and 24. In addition, each side portion has a corresponding cam surfaces 25 and 26.

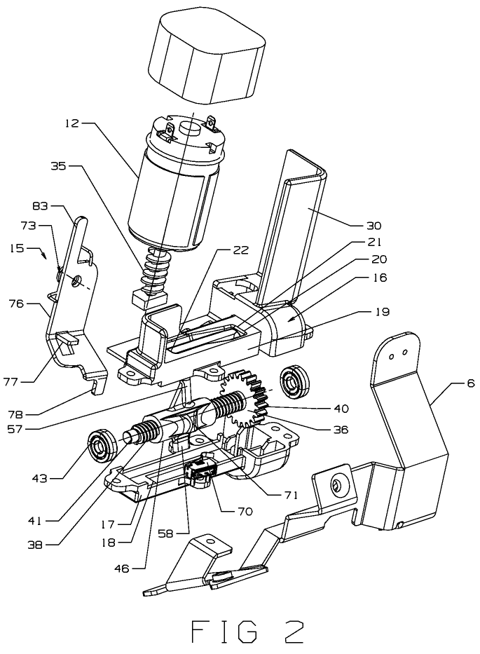

As best as shown in FIGS. 2-5, housing assembly 16 includes a support bracket 30 that is fixedly connected to reversible motor 12. More specifically, support bracket 30 interconnects mounting bracket 6 and reversible motor 12. In any event, reversible motor 12 includes an output shaft (not separately labeled) that is connected to a drive train 33. Drive train 33 includes a pinion gear 35 operatively connected to a cog 36 that is supported by a drive screw 38. Drive screw 38 includes a first end portion 40 connected to cog 36 that leads to a second end portion 41 that is rotateably supported by a bushing 43. As shown, first and second end portions 40 and 41 are located proximate to the first and second travel limits positions 21 and 22.

In a manner that will become more fully evident below, drive screw 38 is operated or rotated in two opposite directions to translate and rotate a carrier nut 46 between a “home position” and a latched position and between the home position and an unlatched position wherein the home position further includes at least two distinct operational positions. In accordance with an exemplary embodiment the carrier nut has a threaded opening to engage the threads of the drive screw so that rotational movement of the drive screw will cause the carrier nut to translate along an axis defined by the carrier nut.

Furthermore, and as will be described herein rotation of the carrier nut is allowed prior to linear translation. Moreover, the openings 18 and 20 are configured that upon loss of power the carrier nut is capable of being rotated to move a drive lug out of contact with either the cinching lever or the detent release lever.

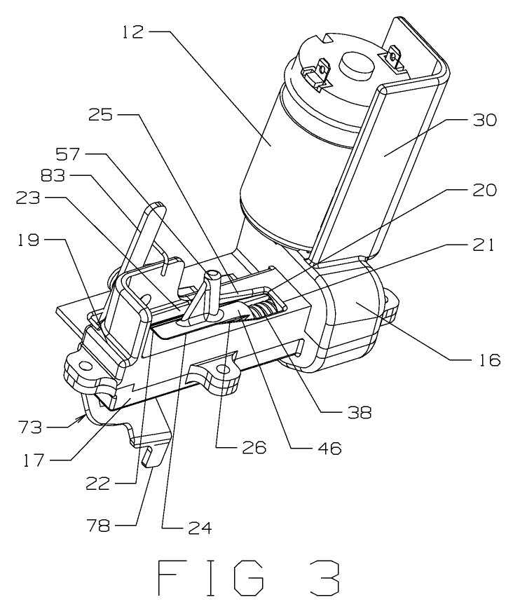

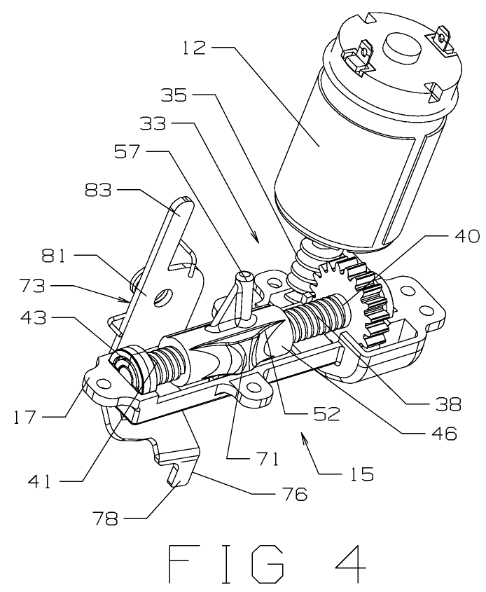

Referring now to FIGS. 3 and 4, carrier nut 46 includes a main body 53 that is generally cylindrical in shape and is provided with a central threaded bore to engage the threads of the drive screw. In addition, carrier nut 46 includes a first appendage or nut pin or drive pin 57, which is configured to translate and rotate within opening 20 as the drive screw 38 is rotated.

As will be discussed more fully below, carrier nut and nut pin or drive pin 57 transitions within opening 20 when cinching latch assembly 2 shifts between a home position and a latched configuration illustrated in FIGS. 1 and 1A respectively. In addition, carrier nut and nut pin 57 transitions within opening 20 when cinching latch assembly 2 shifts between a home position and an unlatched configuration illustrated in FIGS. 1 and 1B respectively.

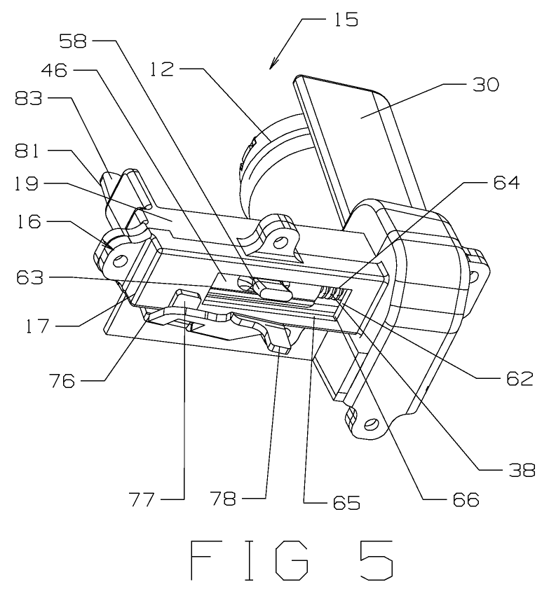

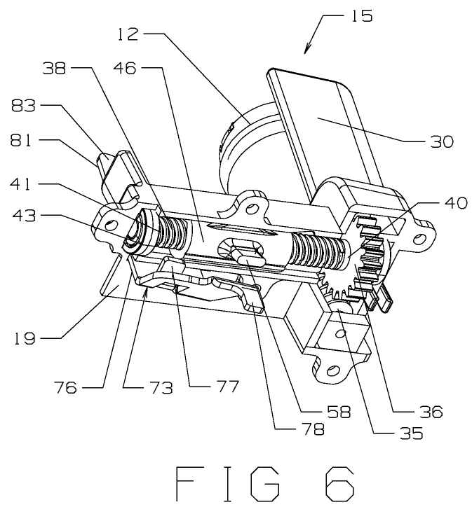

In accordance with one exemplary embodiment the carrier nut further comprises a drive lug 58 (FIGS. 5 and 6) that also translates and rotates within opening 18 of first housing 17. Opening 18 further comprises end portions or travel limit positions 62 and 63 which are interconnected through a pair of opposing side portions. In one embodiment the side portions of opening 18 do not have corresponding cam surfaces similar to cam surfaces 25 and 26. Alternatively, opening 18 is configured to have cam surfaces similar to those of opening 20.

In accordance with an exemplary embodiment the openings 18 and 20 are disposed on opposite sides of housing assembly 16 however, in one alternative exemplary embodiment, the housing assembly is configured to have a single opening for receipt of a single appendage of the carrier nut.

Similar to the nut pin 57, the drive lug 58 translates and rotates within opening 18 when cinching latch assembly 2 shifts between a home position and a latched configuration illustrated in FIGS. 1 and 1A respectively and a home position and an un-latched configuration illustrated in FIGS. 1 and 1B respectively.

More specifically and once an associated panel of the vehicle is moved from an open position to a partially closed position a striker of the door panel engages the fork bolt to rotate it from an unlatched position to a secondary position wherein the cinching latch assembly 2 is then activated to rotate the fork bolt from the secondary position to a primary position to draw the panel to a fully closed position, i.e., cinching the panel. As used herein, the secondary position of the fork bolt corresponds to one of two “home positions” of the carrier nut. Each of the two home positions have a different location of the drive lug and the drive pin.

In accordance with an exemplary embodiment of the present invention when the fork bolt is rotated from the unlatched position to a secondary position a sensor positioned to detect movement of the fork bolt from the unlatched position to the secondary position provides a signal to actuate or activate the motor to drive the carrier nut from the home position to the latched position (e.g., power cinching of the latch). During this movement the drive lug contacts the cinching lever and causes the fork bolt to rotate into the latched or primary position.

As the fork bolt is rotated from the secondary position to the primary or latched position the nut pin 57 and the drive lug 58 travel from the home position (FIG. 1) towards one of the end portions of their respective openings and then back towards the home position. In order to achieve this movement the reversible motor is operated in a first direction causing the carrier nut to translate from the home position to latched position and then in a second direction causing the carrier nut to translate from latched position to the home position.

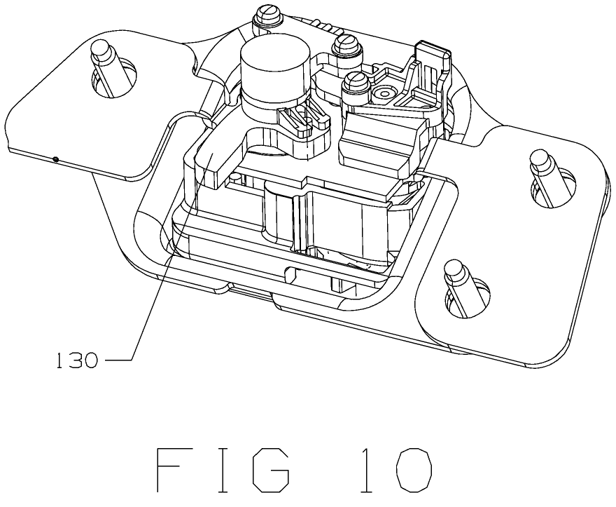

As the carrier nut translates from the home position towards the latched position and from the latched position to the home position the carrier nut is rotated such that nut pin 57 and drive lug 58 are moved in at least two directions as the carrier nut is moved from the home position to the latched position and then from the latched position back to the home position. As the carrier nut moves from home position to the latched position the motor drives the drive screw in one direction causing a linear movement of the carrier nut. In addition, and during this movement the nut pin contacts a cam surface of the opening to cause rotational movement of the carrier nut and the nut pin and the drive lug. During this movement the drive lug rotates into a position such that is contacts a cinching lever 130 (See FIG. 10) secured to the fork bolt to rotate the fork bolt from the secondary position to the latched position.

Once at the latched position, the motor stops and is activated in an opposite direction to translate the carrier nut from the latched position to the home position. During this change of motor direction the carrier nut will rotate until the either the nut pin or the drive lug contacts a side wall of their respective opening causing the carrier nut to then translate back from the latched position to the home position. This rotation of the carrier nut and the drive lug causes the drive lug to no longer be in contact with the cinching lever of the fork bolt (e.g., allowing movement back to the home position).

In order to latch or transition latching mechanism 2 from the home position (FIG. 1) to a latched configuration (FIG. 1B), reversible motor 12 is operated in a first direction causing carrier nut 46 to transition toward cog 36. As carrier nut 46 transitions toward cog 36, nut pin 57, as a result of a rotational force imparted by drive screw 38, moves into contact with side portion 23 of opening 20 with continued operation of reversible motor 12 causing nut pin 57 to transition along first cam surface 25. At the same time, drive lug 58 moves towards a side portion 64 of opening 18. As nut pin 57 transitions along first cam surface 25, drive lug 58 moves into contact with a fork bolt 67 or a cinching latch secured to the fork bolt to draw the associated panel to a fully closed position namely, rotating the fork bolt from the secondary or partially latched position to the primary or fully latched position wherein an opening of the fork bolt pulls a striker of the panel into the latch assembly.

Once the nut pin 57 reaches first travel stop 20 and the fork bolt 67 is in the latched position the fork bolt 67 is engaged by a detent lever 69 and retained in the latched configuration. Thereafter, the motor is then operated in a reverse direction (e.g., opposite to the direction causing the carrier nut to translate to home from latched) such as by changing input voltage polarity this causes nut pin 57 to move into contact with side portion 24 of opening 20. That is, rotation of drive screw 38 forces nut pin 57 from contacting side portion 23 into contact with side portion 24 thus, nut pin 57 and drive lug 58 rotate first before the carrier nut returns to the home position. Alternatively, contact of the drive lug to a side portion of opening 18 may be used to effect movement back towards the home position. Once the carrier nut is rotated the drive lug is free to move back to the home position (e.g., the drive lug no longer contacts the fork bolt or a cinching lever secured to the fork bolt and the drive lug is free to move back to the home position without effecting the state of the fork bolt).

Continued operating of motor 12 shifts carrier nut 46 back towards the home position, with nut pin 57 sliding along second can surface 26.

In order to effect movement of the carrier nut from the home position to the latched position and back to the home position a micro-switch 70 is positioned to contact a cam surface 71 of the carrier nut. Cam surface 71 has opposing inclined surfaces each being configured to engage the micro-switch as the carrier nut moves back and forth from and to the home position. In accordance with an exemplary embodiment, the micro-switch is normally open (e.g., closing of the switch stops the power to the motor). Referring back now to the previous example (e.g., cinching or movement from home to latched and back to home), once a sensor detects the fork bolt is rotated from the unlatched position to the secondary position the motor is energized and the carrier nut travels toward the latched position the cam surface 71 moves away from the micro-switch and the motor operates until the fork bolt is in the latched position wherein a fork bolt switch located in the latch assembly provides a signal to a controller indicating that the fork bolt is latched. Thereafter, the polarity is reversed to the motor and the carrier nut is driven back towards the home position wherein the cam surface 71 contacts the micro-switch 70 and the motor is stopped and the carrier nut is at the home position.

In order to unlatch or transition latching mechanism 2 from the home position (FIG. 1) to an unlatched configuration (FIG. 1A), reversible motor 12 is operated in a direction that causes nut pin 57 to move towards second end portion 22. That is, rotation of drive screw 38 forces nut pin 57 into contact with side portion 24. Continued operating of motor 12 shifts carrier nut 46 toward bushing 43 and nut pin 57 is slid within opening 20. At the same time, drive lug 58 moves into contact with a detent release lever 73. As best shown in FIGS. 4 and 5, detent release lever 73 includes a first end portion 76 having an actuating arm 77 and a detent release arm 78. Detent release lever 73 further includes a second end portion 81 having an override arm 83. With this arrangement, drive lug 58 moves into contact with actuating arm 77 causing detent release lever 73 to pivot relative to housing assembly 16 which causes the fork bolt to rotate from the latched position to the unlatched position. In one embodiment, pivotal movement of the detent release lever 73 from non-releasing position to a releasing position causes detent lever 69 to be moved out of a blocking position thus, the fork bolt is free to rotate. The movement of detent lever 69 is effected by detent release arm 78. At this point, the door of the vehicle can now be opened. Detent release lever 73 is spring biased into position by a spring 90 such that upon movement of the carrier nut back to the home position the detent release lever moves back into an un-releasing position.

Furthermore, once the detent release lever is actuated a detent switch in the latch assembly provides a signal to a microcontroller indicating that the fork bolt is in the unlatched position. Accordingly, the polarity to the motor is reversed and the carrier nut is driven from the unlatched position to the home position. Here, the carrier nut is rotated until the drive pin or nut pin contacts side wall 23 thus causing rotation of the carrier nut before linear movement and causing the drive lug to no longer be engaged with the detent release lever. Then the carrier nut moves from the unlatched position to the home position wherein the cam surface 71 contacts the micro-switch and stops the motor when the carrier nut is in the home position and is now ready to move again towards the latched configuration.

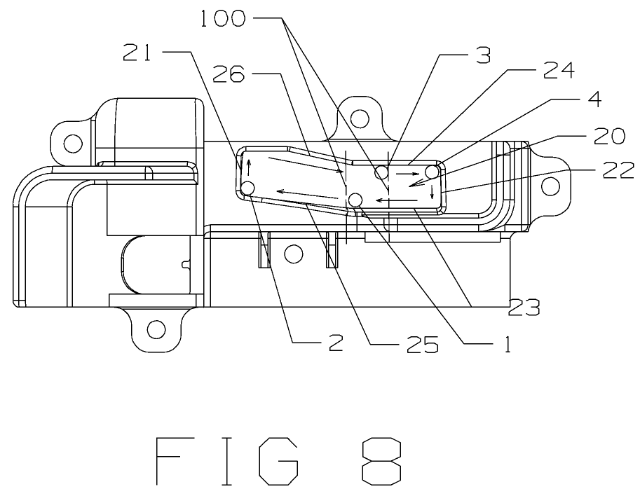

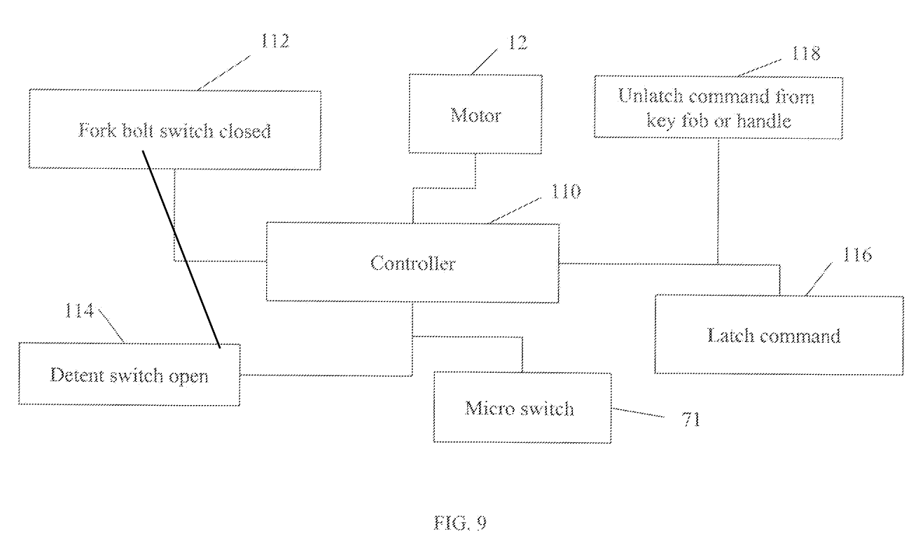

Referring now to FIGS. 8 and 9, a schematic illustration of exemplary embodiments of the present invention are illustrated. Here FIG. 8 depicts opening 20 and the movement of the drive pin or nut pin therein shown by the circle identified by positions 1-4 while FIG. 9 illustrates schematically operation of the system. It being understood that the drive pin or nut pin is secured to or integrally formed with the carrier nut. As shown, the home positions are illustrated by having drive pin or nut pin 57 in the area depicted by the dashed lines 100. Position 1 illustrates the drive pin in the first home position after traveling there from the unlatched position 4. In order to move from position 1 to position 2 (latched), the drive screw is rotated in a first direction causing the carrier nut and the drive pin to travel in the direction of the arrows. Here the drive pin contacts the cam surface 25, which rotates the carrier nut and the drive pin and drive lug (e.g., changing positions of the same) as the carrier nut moves from the first home position to latched the drive lug causes the fork bolt to rotate from secondary to primary or latched. At this point, the drive pin is at position 2 and a fork bolt switch indicates that the fork bolt is latched thus, the motor stops and the polarity is reversed and the carrier nut rotates until the drive pin contacts an opposite side of the opening and slides along cam surface 26 until reaching position 3, which corresponds to the second home position. Note, the first home position and the second home position are different in that the drive pin and the drive lug are in two different locations when in the first and second home positions. Here the cam surface of the carrier nut contacts the micro-switch and power is shut off until an unlatch command is received by the cinching latch assembly controller. Moreover, the drive lug is moved or rotated to no longer contact the cinching lever and the fork bolt is retained in the latched or primary position by the detent lever.

Once an unlatch command is received, the drive pin travels from position 3 to position 4 (e.g., second home position to unlatched) and once the detent switch indicates the fork bolt is in the unlatched position, the polarity to the motor is reversed and the carrier nut and the drive pin rotate until the opposite side of the opening is contacted and then the carrier nut translates towards the first home position wherein the power is shut off once the cam surface of the carrier nut contacts the micro-switch and the carrier nut stays in the first home position until a latch command is received by the cinching latch assembly controller. As illustrated, two home positions are provided one after latching and one after unlatching wherein the carrier nut is rotated to allow the drive lug to no longer engage the cinching lever or the detent release lever and be positioned to engage the detent release lever or the cinching lever. Moreover, and as discussed above and in the event of power loss at any position the carrier nut is capable of being rotated to move the location of the drive lug without requiring linear translation of the carrier nut.

FIG. 9 illustrates schematically, a microcontroller 110 that receives signals from a fork bolt switch 112, a detent switch 114, micro-switch 71, a latch command device 116 and an unlatch command device 118 in order to operate the motor. In accordance with an exemplary embodiment, the fork bolt switch is positioned to indicate when the fork bolt is closed while the detent switch is positioned to indicate when the fork bolt is unlatched, wherein signals are provided to the microcontroller. In addition, the fork bolt switch 112 is configured to provide a signal to activate the motor when the fork bolt has been rotated from unlatched to secondary and a signal to reverse the motor when a primary latch state has been reached. Latch and unlatch command devices may be any one of key fobs (RF transmitters) or buttons associated with the latch device of the vehicle (e.g., handles, etc.). Controller is any one of a microprocessor or microcontroller comprising programmable logic that is configured to receive signals from the fork bolt switch 112, the detent switch 114, the micro-switch 71, the latch command device 116 and the unlatch command device 118 in order to provide operate the motor by connecting power to the motor to effect movement in either direction.

It is understood that a controller operating in response to a computer program may implement the processing of the above description. In order to perform the prescribed functions and desired processing, as well as the computations therefore, the controller may include, but not be limited to, a processor(s), computer(s), memory, storage, register(s), timing, interrupt(s), communication interfaces, and input/output signal interfaces, as well as combinations comprising at least one of the foregoing.

As described above, algorithms for implementing exemplary embodiments of the present invention can be embodied in the form of computer-implemented processes and apparatuses for practicing those processes. The algorithms can also be embodied in the form of computer program code containing instructions embodied in tangible media, such as floppy diskettes, CD-ROMs, hard drives, or any other computer-readable storage medium, wherein, when the computer program code is loaded into and executed by a computer and/or controller, the computer becomes an apparatus for practicing exemplary embodiments of the invention. Existing systems having reprogrammable storage (e.g., flash memory) that can be updated to implement various aspects of command code, the algorithms can also be embodied in the form of computer program code, for example, whether stored in a storage medium, loaded into and/or executed by a computer, or transmitted over some transmission medium, such as over electrical wiring or cabling, through fiber optics, or via electromagnetic radiation, wherein, when the computer program code is loaded into and executed by a computer. When implemented on a general-purpose microprocessor, the computer program code segments configure the microprocessor to create specific logic circuits.

These instructions may reside, for example, in RAM of the computer or controller. Alternatively, the instructions may be contained on a data storage device with a computer readable medium, such as a computer diskette. Or, the instructions may be stored on a magnetic tape, conventional hard disk drive, electronic read-only memory, optical storage device, or other appropriate data storage device. In an illustrative embodiment of the invention, the computer-executable instructions may be lines of compiled C++ compatible code.

In an exemplary embodiment the controller includes logic for evaluating signals from the plurality of sensors to determine when and in what direction to operate the motor.

In the event that power is lost to reversible motor 12, cinching latch assembly 2 includes a manual override. More specifically, in the event of a mechanical failure, or power is lost at reversible motor 12, an access panel (not shown) is opened to provide access to override arm 83. Once accessible, override arm 83 is pivoted to release detent release lever 73 which, in turn, releases fork bolt 67.

Moreover, and in the event power is lost when the drive pin is in between positions 1 and 2 or 3 and 4 the same is simply rotated within the housing to disengage the drive lug from either the cinching lever or the detent release lever.

At this point it should be appreciated that the above-described cinching latch assembly can be easily operated in the event of a mechanical or electrical failure to ensure that an associated vehicle panel can be freely shifted between open and closed positions without requiring the latch to be reset. Moreover, the use of cam surfaces reduces the overall number of operating parts of the cinching latch assembly resulting in manufacturing and cost efficiencies.

While the invention has been described with reference to an exemplary embodiment, it will be understood by those skilled in the art that various changes may be made and equivalents may be substituted for elements thereof without departing from the scope of the invention. In addition, many modifications may be made to adapt a particular situation or material to the teachings of the invention without departing from the essential scope thereof. Therefore, it is intended that the invention not be limited to the particular embodiment disclosed as the best mode contemplated for carrying out this invention, but that the invention will include all embodiments falling within the scope of the appended claims.

What is claimed is:

1. A cinching latch assembly comprising:
a housing having first and second cam surfaces;
a reversible electric motor mounted to the housing;
a drive screw drivingly connected to the reversible motor, the drive screw having a first end portion and a second end portion;
a carrier nut movably positioned on the drive screw, the carrier nut including a first appendage, the drive screw being selectively rotated in a first direction and a second direction to move the carrier nut from a first home position toward the first end portion and then back towards a second home position to establish a latched configuration of the cinching latch assembly, and the drive screw being selectively rotated in the second direction and the first direction to move the carrier nut from the second home position toward the second end portion and then back towards the first home position to establish an unlatched configuration of the cinching latch assembly, the carrier nut and the first appendage moving in at least two different directions as the carrier nut is moved from the first home position to the latched position and as the carrier nut is moved from the latched position to the second home position.

2. The cinching latch assembly according to claim 1, wherein the carrier nut further comprises a second appendage, the first appendage being a nut pin that travels along the first and second cam surfaces and the second appendage being a drive lug, the drive lug being adapted to engage with a fork bolt when the carrier nut travels from the home position to the latched position.

3. The cinching latch assembly according to claim 2, wherein the housing includes an housing assembly having a first portion provided with a first opening and a second portion provided with a second opening the first and second cam surfaces being located in the first opening, the first appendage extending through the first opening and the second appendage extending through the second opening.

4. The cinching latch assembly according to claim 3, wherein the second opening includes first and second end portions interconnected by first and second opposing side portions, each of the first and second end portions defining a travel limit position of the carrier nut.

5. The cinching latch assembly according to claim 1, further comprising: a drive train interconnecting the reversible motor and the drive screw.

6. The cinching latch assembly according to claim 5, wherein the drive train includes a pinion gear operatively connected to the reversible motor and a cog fixedly connected to the drive screw.

7. The cinching latch assembly according to claim 2, wherein drive lug contacts a detent release lever as the carrier nut is moved from the home position to the unlatched position and movement of the detent release lever by the drive lug causes the fork bolt to rotate from the latched configuration to the unlatched configuration.

8. The cinching latch assembly according to claim 7, wherein the detent release lever further comprises a manual override portion.

9. The cinching latch assembly according to claim 3, wherein the first opening and the second opening are each configured to allow rotation of the carrier nut without linear translation of the carrier nut on the drive screw such that the drive lug and the drive pin are moved without linear translation of the carrier nut and the drive lug is capable of being moved away from a detent release lever or a cinching lever of the cinching latch assembly.

10. A method of cinching a latch assembly, the method comprising:
linearly translating a carrier nut from a first home position to a latched position by driving a drive screw in a first direction by a reversible motor;
rotating a fork bolt from a secondary position to a primary latched position when the carrier nut is translated from the first home position to the latched position;
linearly translating the carrier nut from the latched position to a second home position by driving the drive screw is a second direction after the fork bolt is in the primary latched position;
linearly translating the carrier nut from the second home position to an unlatched position by driving the drive screw in the second direction;
rotating the fork bolt from the primary latched position to an unlatched position when the carrier nut is translated from the second home position to the unlatched position; and
linearly translating the carrier nut from the unlatched position to the first home position by driving the drive screw is the first direction.

11. The method as in claim 10, wherein a drive lug of the carrier nut contacts a cinching lever of the fork bolt when the carrier nut translates from the first home position to the latched position.

12. The method as in claim 11, wherein the drive lug rotates away from the cinching lever as the carrier nut translates from the latched position to the second home position.

13. The method as in claim 11, wherein a drive pin of the carrier nut contacts a first cam surface as the carrier nut translates from the first home position to the latched position.

14. The method as in claim 10, wherein a drive pin of the carrier nut contacts a first cam surface as the carrier nut translates from the first home position to the latched position.

15. The method as in claim 10, wherein a drive lug of the carrier nut contacts a detent release lever of the fork bolt when the carrier nut translates from the second home position to the unlatched position.

16. The method as in claim 15, wherein the drive lug rotates away from the detent release lever as the carrier nut translates from the unlatched position to the first home position.

17. The method as in claim 16, wherein a drive pin of the carrier nut contacts a second cam surface as the carrier nut translates from the latched position to the second home position.

18. The method as in claim 15, wherein a drive pin of the carrier nut contacts a second cam surface as the carrier nut translates from the latched position to the second home position.

19. The method as in claim 10, wherein a drive pin and a drive lug of the carrier nut capable of movement within an opening of a housing without linear movement of the carrier nut on the drive screw.
